(19) United States
(12) Patent Application Publication
(10) Pub. No.: US 2025/0254199 A1
(43) Pub. Date: Aug. 7, 2025

(54) CLOUD ASSET MISCONFIGURATION RISK DETECTION AND PREVENTION

(71) Applicant: Tamnoon, Inc., Sammamish, WA (US)

(72) Inventors: Idan David Perez, San Francisco, CA (US); Marina Segal, Sammamish, WA (US)

(21) Appl. No.: 18/435,950

(22) Filed: Feb. 7, 2024

(51) Int. Cl. H04L 9/40; H04L 41/0823; H04L 41/22

(52) U.S. Cl. CPC H04L 63/20; H04L 41/0823; H04L 41/22

(57) ABSTRACT

A device receives input to configure a cloud asset via a user interface. The device determines the input satisfies a security misconfiguration threshold prior to submission of the input to configure the cloud asset. Submission of the input would implement the configuration of the cloud asset. The device updates the user interface to prevent the submission of the input in response to detection of the satisfaction of the security misconfiguration threshold.

### TECHNICAL FIELD

Embodiments of the invention relate to the field of cloud security and, more specifically, to the prevention of misconfiguration of a cloud asset.

### BACKGROUND

Cloud computing refers to running workloads within public, private, or hybrid clouds. Clouds refer to environments that abstract, pool, and share resources across a network. Cloud infrastructure refers to the components or assets needed for cloud computing, including computational hardware, storage, abstracted resources, and other network resources. For example, these environments often include cloud services, such as one or more of software as a service (SaaS), providing a software application hosted and delivered via a cloud, infrastructure as a service (IaaS), providing cloud-based computing infrastructure, such as servers, operating systems, storage, etc., and a platform as a service (PaaS), providing a cloud-based framework for provisioning and otherwise managing a combination of computing environment and one or more applications.

Cloud security generally refers to policies, applications, and other controls for protecting cloud assets (e.g., cloud infrastructure assets, cloud application assets, etc.). Each cloud service can provide its own cloud security controls accessed, e.g., via a browser-based user interface. Cloud security can include identity management, access management, threat detection/protection, resource allocation, etc. Additionally, a platform such as cloud-native application protection platform (CNAPP) can unify security capabilities across multiple cloud services/assets. A CNAPP integrates multiple cloud security solutions, such as cloud security posture management (CSPM), cloud access security brokers (CASB), cloud infrastructure entitlement management (CIEM), cloud workload protection platforms (CWPP), data protection, etc., in a single user interface.

### BRIEF DESCRIPTION OF THE DRAWINGS

The invention may best be understood by referring to the following description and accompanying drawings that are used to illustrate embodiments of the invention. In the drawings:

FIG. 1 illustrates an example of a computer system to detect risk in configuration input for a cloud asset and prevent the submission of the input, according to some embodiments of the invention.

FIG. 2 is a flow diagram of an example method to detect risk in configuration input for a cloud asset and prevent the submission of the input in accordance with some embodiments of the present disclosure.

FIG. 3 illustrates an example of a user interface updated to prevent submission of configuration input for a cloud asset in response to detecting risk in the input, according to some embodiments of the invention.

FIG. 4 is another flow diagram of an example method to detect risk in configuration input for a cloud asset and prevent the submission of the input in accordance with some embodiments of the present disclosure.

### DETAILED DESCRIPTION

Conventional cloud security solutions provide monitoring and reporting on potential risks in the policies and settings for cloud assets, such as cloud infrastructure and/or cloud applications. Both the adoption of and complexity of solutions dependent upon cloud computing and infrastructure continue to increase. As a result, a critical alert as to the misconfiguration of a cloud asset can be buried in the noise of a larger report or multiple reports. Furthermore, such a misconfiguration will only be corrected after the cloud asset was exposed to the detected risk.

Aspects of the present disclosure address the above and other deficiencies by detecting risk in a configuration input prior to submission and implementation of that input for a given cloud asset. Upon receiving the input via a user interface, an embodiment detects that the input presents a misconfiguration risk and modifies the user interface to prevent the submission of the input. Additional details and benefits of this approach as set forth below with reference to illustrated examples.

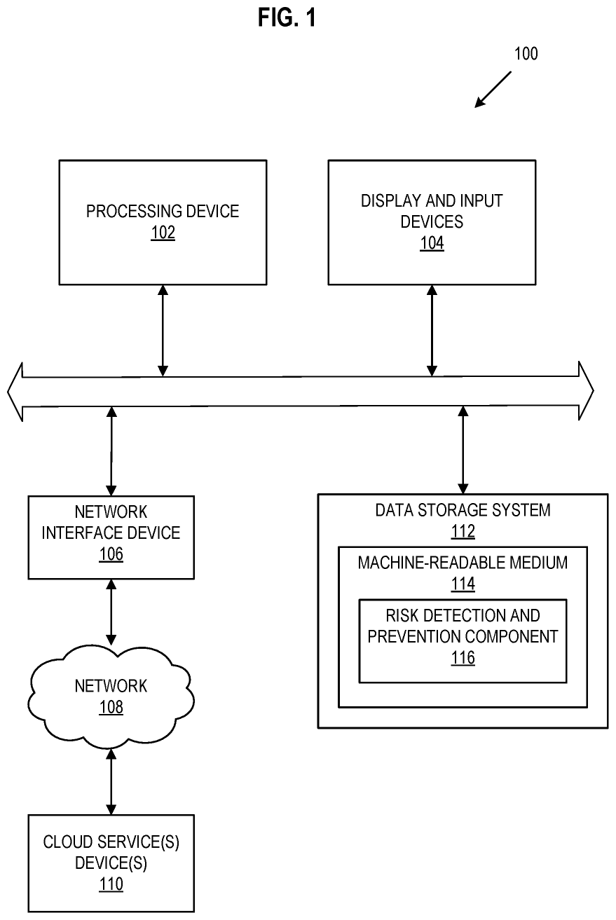

FIG. 1 illustrates an example of a computer system 100 to detect risk in configuration input for a cloud asset and prevent the submission of the input, according to some embodiments of the invention. In some embodiments, the computer system 100 is a personal computer (PC), a tablet PC, a Personal Digital Assistant (PDA), a cellular telephone, a web appliance, a server, a network device, or any machine capable of executing a set of instructions (sequential or otherwise) that specify actions to be taken by that machine. Further, while a single system or machine is illustrated, the term “machine” shall also be taken to include any collection of machines that individually or jointly execute a set (or multiple sets) of instructions to perform any of the methods described herein.

The computer system 100 includes a processing device 102. The processing device 102 represents one or more general-purpose processing devices—e.g., a microprocessor, central processing unit, etc. The processing device 102 implements one or more instruction sets—e.g., a complex instruction set computing (CISC) microprocessor, reduced instruction set computing (RISC) microprocessor, very long instruction word (VLIW) microprocessor, etc. Additionally, the processing device 102 can be a special purpose processing device, such as an application specific integrated circuit (ASIC), a field programmable gate array (FPGA), etc.

The computer system 100 further includes one or more display and input devices 104. An input device enables user input to give a command to the computer system 100 to configure a cloud asset. An output device displays the user interface for receiving and submitting configuration inputs as described herein. For example, a touchscreen can serve as both a display and input device. Other display devices include a monitor, virtual reality headset, a projector, etc. Other input devices include a keyboard, mouse, a stylus, a controller, a camera to capture user movement/gestures, etc.

The computer system 100 further includes a network interface device 106 to communicate over a network 108. For example, instead of or in addition to receiving an input from an input device within the system, the computer system 100 can receive an input via another computer system via the network 108. Additionally, instead of or in addition to displaying an output to a display device within the system, the computer system 100 can send an output via the network 108 to be rendered via a display device of another computer system.

The computer system 100 can also communicate with one or more cloud services devices 110 via the network 108. Exemplary cloud services include SaaS providers, PaaS providers, IaaS providers, and/or other cloud-based enterprise services. A user of the computer system 100 can access such cloud services to configure a cloud asset as described in further detail below.

The computer system 100 further includes a data storage system 112. The data storage system 112 includes a machine-readable medium 114 (also known as a computer-readable medium) on which is stored instructions embodying a risk detection and prevention component 116 to perform the operations described herein. A machine-readable medium includes any mechanism for storing information in a form readable by a machine (e.g., a computer). In some embodiments, a machine-readable (e.g., computer-readable) medium includes a machine-readable storage medium such as a read only memory (“ROM”), random access memory (“RAM”), magnetic disk storage media, optical storage media, flash memory components, etc.

The risk detection and prevention component 116 detects a risk in a configuration input prior to submission and implementation of that input for a given cloud asset. Upon receiving the input via a user interface, the risk detection and prevention component 116 modifies the user interface to prevent the submission of the input. As a result, the risk detection and prevention component 116 blocks the implementation of a detected misconfiguration or potential vulnerability (referred to herein collectively as “misconfiguration”). Additionally, the risk detection and prevention component 116 can display an alert to describe to a user why the submission was prevented. The risk detection and prevention component 116 can also reside, completely or at least partially, within the processing device 102 during execution thereof by the computer system 100.

Aspects of the inventive subject matter described herein may be embodied, at least in part, in software. That is, a computer system or other data processing system, such as computer system 100 or other system including the risk detection and prevention component 116, may carry out the computer-implemented methods 200 and 400 in response to its processor executing sequences of instructions contained in a memory or other non-transitory machine-readable storage medium. In one embodiment, the risk detection and prevention component 116 is embodied in a web browser plugin, extension, or other application running on top of or otherwise interpreting the markup language of a web browser (collectively referred to herein as a plugin for the case of providing examples). For example, the computer system 100 accesses a user interface to configure one or more cloud services via a web browser. As a plugin, the risk detection and prevention component 116 can detect and prevent the submission of a cloud asset misconfiguration for multiple cloud services. The software may further be transmitted or received over a network 108 via a network interface 106. For example, the machine-readable medium 114 and risk detection and prevention component 116 are implemented within one or more of the cloud service devices 110. In some embodiments, the risk detection and prevention component 116 is a component of the cloud service configuration service, CNAPP service, or other cloud service presenting the configuration user interface and receiving cloud asset configuration input.

In various embodiments, hardwired circuitry may be used in combination with the software instructions to implement the present embodiments. It will also be appreciated that additional components, not shown, may also be part of computer system 100, and, in some embodiments, fewer components than that shown in FIG. 1 may also be used in computer system 100.

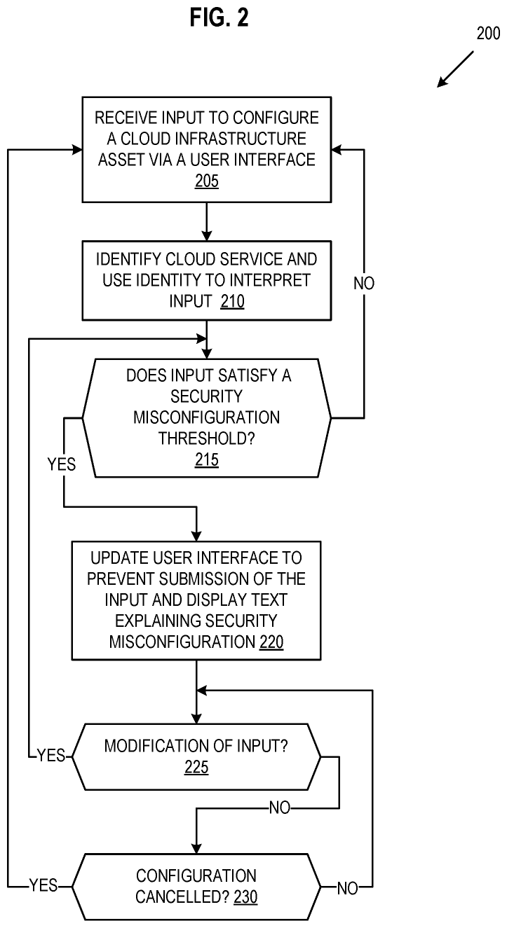

FIG. 2 is a flow diagram of an example method 200 to detect risk in configuration input for a cloud asset and prevent the submission of the input in accordance with some embodiments of the present disclosure. The method 200 can be performed by hardware (e.g., a processing device, circuitry, dedicated logic, programmable logic, etc.), software (e.g., instructions executed by a processing device), or a combination thereof. In some embodiments, the method 200 is performed by a risk detection and prevention component 116, e.g., as described with reference to FIG. 1. For case of explanation, the operations are described as being performed by a processing device. Although operations are illustrated in a particular order, unless otherwise specified, the order can be modified, operations can be performed in parallel, one or more operations can be omitted, etc.

At operation 205, the processing device receives input to configure a cloud asset via a user interface. In a web browser plugin embodiment, receiving the input includes accessing the source markup language for the web browser and parsing the webpage to identify user input received via the web browser, the rule or policy the input is intended to update, the cloud asset impacted by the input, etc. For example, the input can be text input, selection of a drop-down menu item, selection of a box or button to activate or deactivate a feature, etc.

One example of a cloud asset configuration includes inbound traffic rules that control what incoming traffic is permitted to access storage, application(s), or other cloud-based assets. This can include defining a port range, address range, or other network traffic parameter. Other cloud asset configurations include encryption settings of a cloud-based storage instance, access permissions, user security/authentication settings, as well as other settings for cloud-based hardware and software components, such as servers, storage, networking, virtual machines/containers, applications, user identities, etc.

At operation 210, the processing device optionally identifies a cloud service providing the user interface and/or managing the cloud asset. For example, in a web browser plugin embodiment, the accessing of the source markup language can include identifying the provider of the user interface and/or the provider of the cloud asset being managed. Different cloud services can use different terminology, implement rules differently, or present other factors that impact the detection of a misconfiguration risk. As such, embodiments can use the identification of the cloud service to interpret the input for risk evaluation. For example, the processing device can use a lookup table or other data structure to map an input parameter and/or asset in one cloud environment to another cloud environment, to neutral terminology, etc. Additionally or alternatively, the processing device can use the cloud service identity as an indicator of whether the input presents a risk. Other embodiments are configured to operate within or for a specific cloud service and, as a result, bypass operation 210.

At operation 215, the processing device determines if the input satisfies a security misconfiguration threshold. Continuing the example above of an input to configure an inbound traffic rule for a cloud asset, an input to permit inbound traffic for a range of addresses that is wider than threshold, that would permit inbound traffic from unauthorized users, etc. can be detected as satisfying a security misconfiguration threshold. In one embodiment, the processing device uses the cloud asset identity or category to look up one or more security policies that apply. For example, two of the same type of asset may have different security profiles and, as a result, be subject to different security misconfiguration evaluations. This enables the cloud service to permit, e.g., wide access to low-risk resources while maintaining strict access to high-risk resources. Each applicable security policy can have one or more security misconfiguration thresholds. Such thresholds can be permitted/unpermitted values, ranges, or other configuration parameters against which the processing device compares input value(s). Additionally, as described with reference to operation 210, the processing device can also use the combination asset and the cloud service identity to look up a security misconfiguration threshold. Other examples of security misconfiguration thresholds include permitting access to a cloud asset on one or more specified ports, permitting public access to a cloud asset via a registry, subnet, or other configuration, allowing an administrator to forgo multi-factor authentication, permitting a cloud asset to be unencrypted, a certificate being exposed to a known bug, a cloud asset with default administrative access, etc. In one embodiment, the processing device maintains predefined input values as security misconfiguration thresholds. In some embodiments, the processing device uses key words to match the input to a security misconfiguration threshold.

In one embodiment, the security misconfiguration threshold can be added, edited, or deleted by a user. For example, an administrator or other user can access and modify a set of one or more rules that define misconfiguration thresholds for one or more cloud services, assets, etc.

If the input satisfies a security misconfiguration threshold, the method 200 proceeds to operation 220. Otherwise, the method 200 returns to operation 205 to continue to monitor for additional input.

At operation 220, the processing device updates the user interface to prevent submission of the input. For example, the processing device injects code or otherwise modifies the markup language for the browser-based user interface to disable a mechanism for the user to submit the input and implement the corresponding configuration of the cloud asset. In one embodiment, this update includes disabling a user interface button or other browser element (input box, drop-down item, etc.) used to submit the input. Additionally, the processing device can update the visual appearance of the user interface element to indicate that the element has been disabled.

In one embodiment, the processing device further updates the user interface to include an explanation of security misconfiguration. For example, the processing device can generate a pop-up text window or other notification including text to explain why the submission of the input has been prevented. In one embodiment, the lookup table or data structure that maps an asset to a security misconfiguration threshold can further map to text to explain the policy violation. In other embodiments, the explanation is a link to a webpage with an explanation or a media file to provide an audio or video explanation.

In one embodiment, the processing device further provides the user with an opportunity to override the prevention of the current cloud asset configuration. For example, the processing device can add an override button to the text explanation to allow the user to choose a temporary/one-time override of the detected potential security misconfiguration. Additionally or alternatively, the user may override the input prevention by way of another input—e.g., selection via a drop-down menu, predefined keyboard input, etc.

At operation 225, the processing device determines if the input identified as a security misconfiguration has been modified. For example, the processing device monitors the user interface to detect if the user changes the input to replace a value, update a range of values, etc. If the input has been modified, the method 200 returns to operation 215 to evaluate if the modified input still satisfies the security misconfiguration threshold (and, if not, update the user interface to permit submission of the input). If the input has not been modified, the method 200 proceeds to operation 230.

At operation 230, the processing device determines if the user configuration including the misconfiguration input has been cancelled. If the configuration has been canceled, the method 200 returns to operation 205 to continue to monitor for additional input. Otherwise, the method 200 returns to operation 225 to continue to monitor for a modification of the input or cancellation of the configuration attempt.

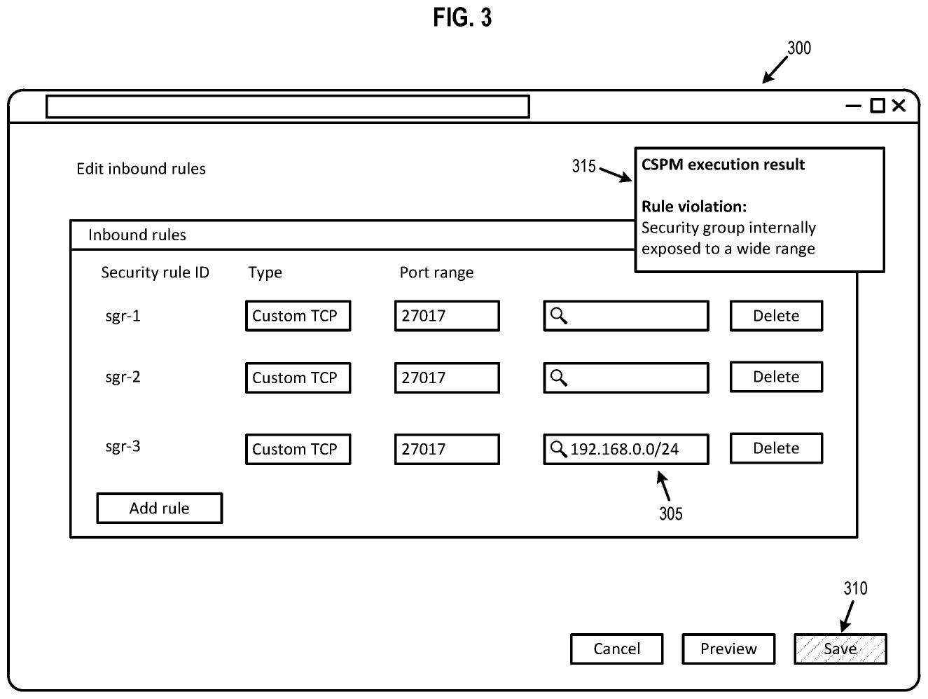

FIG. 3 illustrates an example of a user interface 300 updated to prevent submission of configuration input for a cloud asset in response to detecting risk in the input, according to some embodiments of the invention. The user interface 300 is displayed within a web browser and provides input boxes for a user to configure inbound traffic rules for cloud assets. In the illustrated example, each security rule can apply to one or more different assets. Cloud assets can be identified individually or in sets by way of security groups. The input box 305 for security rule ID sgr-3 includes a transmission control protocol (TCP) address as input to permit inbound traffic from that address to reach the identified security group. The risk detection and prevention component 116 detects that this address is, e.g., associated with an internal router or network infrastructure that inappropriately permits inbound traffic to the asset from a wide range (e.g., in terms of internal subnet scope). In response to detecting that this change violates a security policy, the risk detection and prevention component 116 disables the save button 310 to prevent the user from submitting and implementing this change. In other words, user interaction with save button 310 will not save the value entered into input box 305. The disabling of the save button 310 is illustrated by the shading/updating of the button's color. Additionally, the risk detection and prevention component 116 displays a text explanation 315 of the rule violation that triggered the prevention of submission of this input.

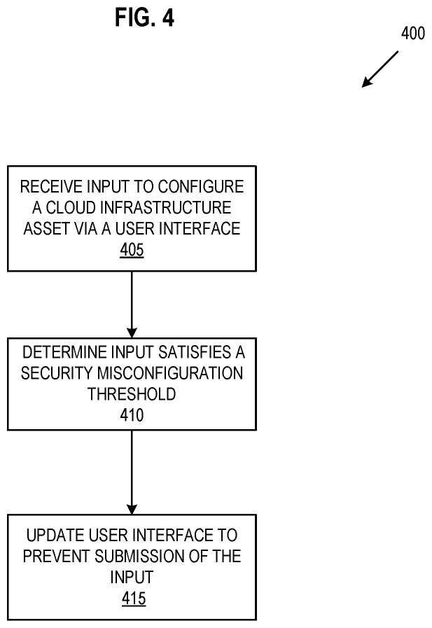

FIG. 4 is another flow diagram of an example method to detect risk in configuration input for a cloud asset and prevent the submission of the input in accordance with some embodiments of the present disclosure. The method 400 can be performed by hardware (e.g., a processing device, circuitry, dedicated logic, programmable logic, etc.), software (e.g., instructions executed by a processing device), or a combination thereof. In some embodiments, the method 400 is performed by a risk detection and prevention component 116, e.g., as described with reference to FIG. 1. For ease of explanation, the operations are described as being performed by a processing device. Although operations are illustrated in a particular order, unless otherwise specified, the order can be modified, operations can be performed in parallel, one or more operations can be omitted, etc.

At operation 405, the processing device receives input to configure a cloud asset via a user interface. For example, the processing device receives the input as described above with reference to operation 205.

At operation 410, the processing device determines the input satisfies a security misconfiguration threshold prior to submission of the input to configure the cloud asset. The submission of the input would implement the configuration of the cloud asset. For example, the processing device detects the misconfiguration as described above with reference to operation 215.

At operation 415, the processing device updates the user interface to prevent the submission of the input in response to detection of the satisfaction of the security misconfiguration threshold. For example, the processing device updates the user interface as described above with reference to operation 220.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories-static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

In the foregoing specification, the invention has been described with reference to specific exemplary embodiments thereof. Various embodiments and aspects of the invention(s) are described with reference to details discussed in this document, and the accompanying drawings illustrate the various embodiments. The description above and drawings are illustrative of the invention and are not to be construed as limiting the invention. References in the specification to “one embodiment,” “an embodiment,” “an exemplary embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Furthermore, when a particular feature, structure, or characteristic is described in connection with an embodiment, such feature, structure, or characteristic may be implemented in connection with other embodiments whether or not explicitly described. Additionally, as used in this document, the term “exemplary” refers to embodiments that serve as simply an example or illustration. The use of exemplary should not be construed as an indication of preferred examples. Blocks with dashed borders (e.g., large dashes, small dashes, dot-dash, dots) are used to illustrate optional operations that add additional features to embodiments of the invention. However, such notation should not be taken to mean that these are the only options or optional operations, and/or that blocks with solid borders are not optional in some embodiments of the invention. Numerous specific details are described to provide a thorough understanding of various embodiments of the present invention. However, in certain instances, well-known or conventional details are not described in order to provide a concise discussion of embodiments of the present inventions.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving input to configure a cloud asset via a user interface;
determining the input satisfies a security misconfiguration threshold prior to submission of the input to configure the cloud asset, wherein submission of the input implements the configuration of the cloud asset; and
updating the user interface to prevent the submission of the input in response to detection of the satisfaction of the security misconfiguration threshold.

2. The method of claim 1, wherein updating the user interface includes disabling a user interface element such that that user interaction with the user interface element no longer results in submission of input to configure one or more security policies.

3. The method of claim 1, further comprising:
updating the user interface to include an explanation of why the input satisfies the security misconfiguration threshold.

4. The method of claim 1, wherein the user interface is a web browser interface for a cloud service and wherein a web browser plugin updates the cloud service user interface in response to the detection.

5. The method of claim 4, further comprising:
identifying the cloud service, wherein the cloud service is one of a plurality of cloud services, wherein the web browser plugin updates a user interface of another of the plurality of cloud services in response to another misconfiguration to prevent submission of the other misconfiguration, and wherein determining the input satisfies the security misconfiguration threshold includes using the identification of the cloud service to interpret the input.

6. The method of claim 1, further comprising:
receiving input to add or modify the security misconfiguration threshold.

7. The method of claim 1, wherein satisfying the security misconfiguration includes detecting a value within the received input is within or outside of range of values, the method further comprising:
receiving additional input to modify the value;
determining the modified value no longer satisfies the security misconfiguration; and
updating the user interface to allow the submission of the modified value.

8. A non-transitory machine-readable storage medium that provides instructions that, when executed by a processor, cause the processor to perform operations comprising:
receiving input to configure a cloud asset via a user interface;
determining the input satisfies a security misconfiguration threshold prior to submission of the input to configure the cloud asset, wherein submission of the input implements the configuration of the cloud asset; and
updating the user interface to prevent the submission of the input in response to detection of the satisfaction of the security misconfiguration threshold.

9. The non-transitory machine-readable storage medium of claim 8, wherein updating the user interface includes disabling a user interface element such that that user interaction with the user interface element no longer results in submission of input to configure one or more security policies.

10. The non-transitory machine-readable storage medium of claim 8, wherein the processor further performs operations comprising:
updating the user interface to include an explanation of why the input satisfies the security misconfiguration threshold.

11. The non-transitory machine-readable storage medium of claim 8, wherein the user interface is a web browser interface for a cloud service and wherein a web browser plugin updates the cloud service user interface in response to the detection.

12. The non-transitory machine-readable storage medium of claim 11, wherein the processor further performs operations comprising:
identifying the cloud service, wherein the cloud service is one of a plurality of cloud services, wherein the web browser plugin updates a user interface of another of the plurality of cloud services in response to another misconfiguration to prevent submission of the other misconfiguration, and wherein determining the input satisfies the security misconfiguration threshold includes using the identification of the cloud service to interpret the input.

13. The non-transitory machine-readable storage medium of claim 8, wherein the processor further performs operations comprising:
receiving input to add or modify the security misconfiguration threshold.

14. The non-transitory machine-readable storage medium of claim 8, wherein satisfying the security misconfiguration includes detecting a value within the received input is within or outside of range of values, wherein the processor further performs operations comprising:
receiving additional input to modify the value;
determining the modified value no longer satisfies the security misconfiguration; and
updating the user interface to allow the submission of the modified value.

15. A system comprising:
a processing device; and
a memory coupled to the processing device, the memory storing instructions which, when executed by the processing device, cause the system to:
receive input to configure a cloud asset via a user interface;
determine the input satisfies a security misconfiguration threshold prior to submission of the input to configure the cloud asset, wherein submission of the input implements the configuration of the cloud asset; and
update the user interface to prevent the submission of the input in response to detection of the satisfaction of the security misconfiguration threshold.

16. The system of claim 15, wherein updating the user interface includes disabling a user interface element such that that user interaction with the user interface element no longer results in submission of input to configure one or more security policies.

17. The system of claim 15, wherein the instructions further cause the system to:
update the user interface to include an explanation of why the input satisfies the security misconfiguration threshold.

18. The system of claim 15, wherein the user interface is a web browser interface for a cloud service and wherein a web browser plugin updates the cloud service user interface in response to the detection.

19. The system of claim 18, wherein the instructions further cause the system to:
identify the cloud service, wherein the cloud service is one of a plurality of cloud services, wherein the web browser plugin updates a user interface of another of the plurality of cloud services in response to another misconfiguration to prevent submission of the other misconfiguration, and wherein determining the input satisfies the security misconfiguration threshold includes using the identification of the cloud service to interpret the input.

20. The system of claim 15, wherein the instructions further cause the system to:
receive input to add or modify the security misconfiguration threshold.
